(19) United States
(12) Patent Application Publication
(10) Pub. No.: US 2020/0311564 A1
(43) Pub. Date: Oct. 1, 2020

(54) SUPPORT SYSTEM AND STORAGE MEDIUM

(71) Applicant: KABUSHIKI KAISHA TOSHIBA, Minato-ku (JP)

(72) Inventors: Mingtao WANG, Yokohama (JP); Masaya MOTOKUBOTA, Yokohama (JP)

(73) Assignee: KABUSHIKI KAISHA TOSHIBA, Minato-ku (JP)

(21) Appl. No.: 16/737,028

(22) Filed: Jan. 8, 2020

(30) Foreign Application Priority Data
Mar. 25, 2019 (JP) 2019-056795

(51) Int. Cl. G06N 5/02; G06F 40/30

(52) U.S. Cl. CPC G06N 5/02; G06F 40/30

(57) ABSTRACT

According to one embodiment, a support system includes an editor, a problem extractor, and a candidate extractor. The editor displays a first editing region. A plurality of items are editable in the first editing region as a hierarchical structure having mutual subordination. The plurality of items include a requirement and an approach. The approach is for satisfying the requirement. The problem extractor extracts, from a database when the requirement is input to the first editing region, a problem similar to the input requirement. The database includes a plurality of combinations. The combination includes the problem and a solution. The solution is for the problem. The candidate extractor refers to an ontology, extracts other problems associated with the extracted problem, and displays the solutions for the other problem as candidates of the approach for the input requirement.

### CROSS-REFERENCE TO RELATED APPLICATIONS

This application is based upon and claims the benefit of priority from Japanese Patent Application No. 2019-056795, filed on Mar. 25, 2019; the entire contents of which are incorporated herein by reference.

### FIELD

Embodiments described herein relate generally to a support system and a storage medium.

### BACKGROUND

To systematize and reuse knowledge, it is favorable to represent items relating to the knowledge in a hierarchical structure. However, a high specialization level is necessary to represent and reference the knowledge in a hierarchical structure. Therefore, it is desirable to develop technology that can support the representation and reference of the hierarchical structure of the knowledge by a user.

### BRIEF DESCRIPTION OF THE DRAWINGS

FIG. 1 is a block diagram illustrating the configuration of a support system according to an embodiment;

FIG. 2 is a schematic view illustrating GUIs output by the support system according to the embodiment;

FIG. 3 is a schematic view illustrating GUIs output by the support system according to the embodiment;

FIG. 4A and FIG. 4B are schematic views illustrating GUIs output by the support system according to the embodiment;

FIG. 5A and FIG. 5B are schematic views illustrating GUIs output by the support system according to the embodiment;

FIG. 6 is a schematic view illustrating GUIs output by the support system according to the embodiment;

FIG. 7 is a flowchart illustrating the operation of the support system according to the embodiment;

FIG. 8 is a flowchart illustrating the operation of the support system according to the embodiment;

FIG. 9 is a schematic view illustrating GUIs output by the support system according to the embodiment;

FIG. 10 is a schematic view illustrating GUIs output by the support system according to the embodiment; and

FIG. 11 is a schematic view illustrating a part of an ontology.

### DETAILED DESCRIPTION

According to one embodiment, a support system includes an editor, a problem extractor, and a candidate extractor. The editor displays a first editing region. A plurality of items are editable in the first editing region as a hierarchical structure having mutual subordination. The plurality of items include a requirement and an approach. The approach is for satisfying the requirement. The problem extractor extracts, from a database when the requirement is input to the first editing region, a problem similar to the input requirement. The database includes a plurality of combinations. The combination includes the problem and a solution. The solution is for the problem. The candidate extractor refers to an ontology, extracts an other problem associated with the extracted problem, and displays the solution for the other problem as a candidate of the approach for the input requirement.

Various embodiments are described below with reference to the accompanying drawings.

In the specification and drawings, components similar to those described previously or illustrated in an antecedent drawing are marked with like reference numerals, and a detailed description is omitted as appropriate.

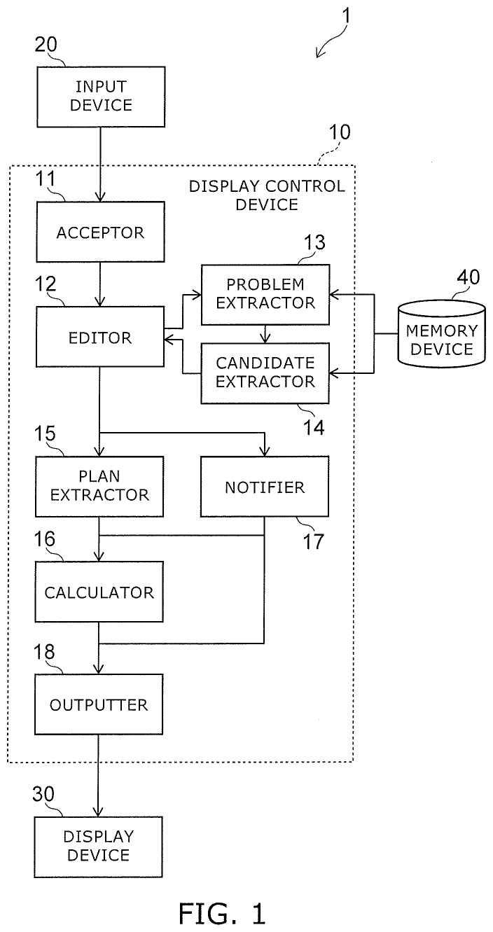

FIG. 1 is a block diagram illustrating the configuration of a support system according to an embodiment.

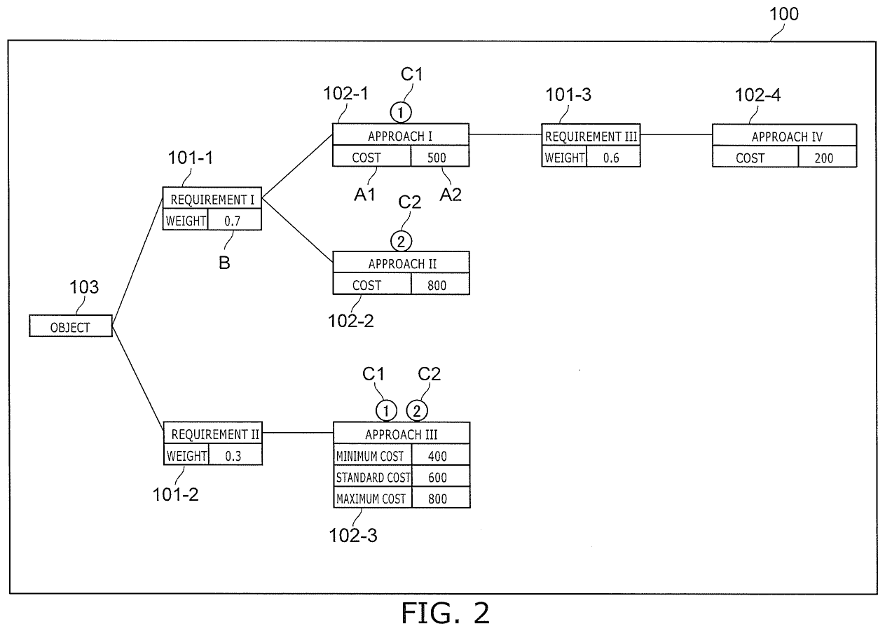

FIG. 2 to FIG. 6 are schematic views illustrating GUIs output by the support system according to the embodiment.

For example, the support system 1 according to the embodiment is used to visualize and efficiently edit the subordinate relationships and the interactions of knowledge. The knowledge is represented by multiple items including approaches and requirements.

As illustrated in FIG. 1, the support system 1 according to the embodiment includes a display control device 10. The display control device 10 performs processing based on information input from an input device 20, and causes a display device 30 to display the information obtained by the processing. The display control device 10 includes a processing circuit including a central processing unit. The display control device 10 refers to a memory device 40 when processing the information. In the example of FIG. 1, the support system 1 further includes the input device 20, the display device 30, and the memory device 40.

The input device 20 is used when a user inputs the information to the display control device 10. The input device 20 includes, for example, at least one of a keyboard, a mouse, a touchpad, or a microphone (a voice input).

The display device 30 displays, to the user, the information output from the display control device 10. The display device 30 includes, for example, at least one of a display or a projector. The input device 20 and the display device 30 can be formed as one body as in a touch panel.

The display control device 10 includes, for example, an acceptor 11, an editor 12, a problem extractor 13, a candidate extractor 14, a plan extractor 15, a calculator 16, a notifier 17, and an outputter 18.

The acceptor 11 accepts the information input to the display control device 10 from the input device 20. The editor 12 causes the display device 30 to display a graphical user interface (GUI) for visualizing and editing the information. The GUI includes, for example, a first editing region 100 illustrated in FIG. 2. The user of the support system 1 uses the input device 20 to make and edit a hierarchical structure relating to the knowledge in the first editing region 100.

In the first editing region 100 as illustrated in FIG. 2, the user makes and edits the hierarchical structure by providing requirements 101 and approaches 102 with mutual subordination. Specifically, an object 103 is set in the highest rank (the root) of the hierarchical structure. The object 103 is technology, a product, etc., used as the object of organizing the knowledge. The requirements 101 are set as children of the object 103. In ranks lower than these requirements 101, other requirements 101 and approaches 102 are arranged to be subordinate to each other. The requirements 101 represent functions, conditions, or problems necessary for realizing the object 103 and the approaches 102. The approaches 102 represent methods that can be employed to satisfy the requirements 101. The approach includes any method, means, approach, solution, process, operation, procedure, technique, course of action, strategy, scheme, or the like that can satisfy a requirement.

The requirements 101 that need to be satisfied to realize the approach 102 are subordinate to the approach 102. Or, at least one other approach 102 that is a subdivision or a paraphrase of the approach 102 may be subordinate to the approach 102.

At least one approach 102 for satisfying the requirement 101 is subordinate to the requirement 101. Or, at least one other requirement 101 that is a subdivision or a paraphrase of the requirement 101 may be subordinate to the requirement 101.

Here, the representation of the hierarchical structure by providing the requirements 101 and the approaches 102 with mutual subordination as illustrated in FIG. 2 is called “knowledge breakdown” (registered trademark). The information that is generated by knowledge breakdown is called “knowledge breakdown information.”

In the example illustrated in FIG. 2, the multiple requirements 101 that include requirements 101-1 to 101-3 are arranged; and the multiple approaches 102 that include approaches 102-1 to 102-4 are arranged. In the example, the two requirements 101-1 and 101-2 that are necessary to realize the object 103 are set. One approach 102-3 is subordinate to the requirement 101-2. The approach 102-1 and the approach 102-2 are subordinate to the requirement 101-1. Also, the requirement 101-3 is subordinate to the approach 102-1; and the approach 102-4 is subordinate to the requirement 101-3.

In the first editing region 100, for example, the requirements 101 and the approaches 102 are written and arranged using the input device 20. The problem extractor 13 refers to the database stored in the memory device 40 when the requirements 101 are input.

The database includes multiple combinations of problems and solutions for the problems. For example, the database stores previous knowledge breakdown information, work reports, case studies, question-answer lists, etc. Problems and solutions for the problems for technology, products, etc., are described in such information.

For example, in previous knowledge breakdown information, the requirements that are described in the knowledge breakdown correspond to problems. The approaches that are subordinate to the requirements correspond to solutions for the problems. In a work report, the discrepancies, the faults, or the like that are described inside the report correspond to problems. The countermeasures and the like for the problems correspond to solutions. In a question-answer list, the questions correspond to problems; and the answers to the questions correspond to solutions.

Or, the database may store a list including multiple combinations of problems and solutions, etc. The format and the type of the information are arbitrary as long as the problems and the solutions stored in the database are included.

When the requirements 101 are input to the first editing region 100, the problem extractor 13 extracts problems which are similar to the requirements 101 from the database stored in the memory device 40. The problem extractor 13 outputs the extracted problems to the candidate extractor 14. The problem extractor 13 may also extract solutions for the problems similar to the requirements 101.

In addition to the multiple problems and solutions, the memory device 40 stores an ontology for problems in the field to which the object 103 belongs. The ontology includes a systematic description of concepts necessary when describing a model of some object. For example, the ontology includes definitions of concepts and relationships between concepts relating to the multiple problems stored in the memory device 40. For example, the ontology is premade by the user or the administrator of the support system 1.

When the problem is extracted by the problem extractor 13, the candidate extractor 14 refers to the ontology stored in the memory device 40. The candidate extractor 14 uses the ontology to extract other problems associated with the extracted problem. The solutions for the extracted other problems are output by the candidate extractor 14 to the editor 12 and displayed by the display device 30 as candidates of the approaches 102 for the input requirement 101.

The editor 12 causes the display device 30 to display the solutions output from the candidate extractor 14. The user may or not use the displayed solutions as the approaches 102. The user performs the knowledge breakdown by providing mutual subordination of the multiple requirements 101 and the multiple approaches 102 while referring to the displayed candidates of the approaches 102.

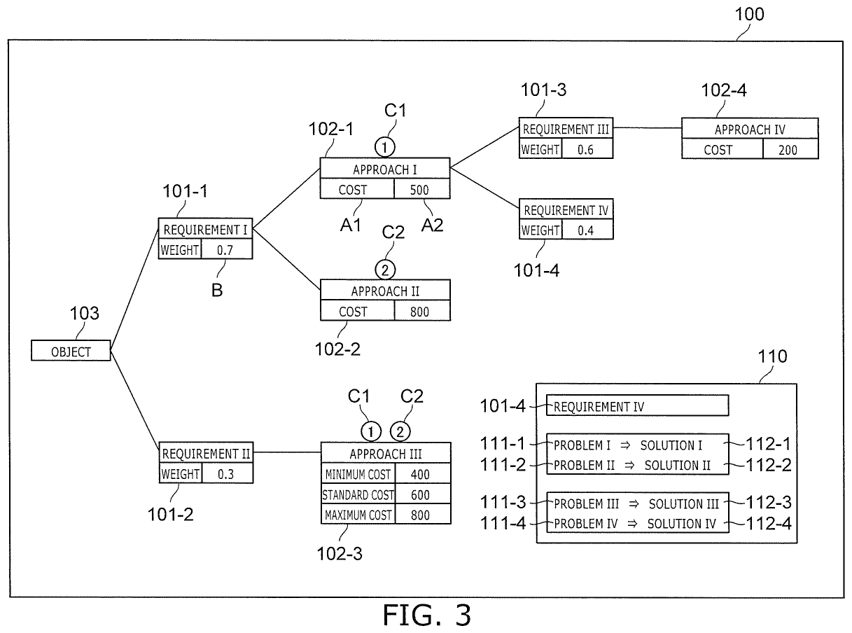

For example, in the state illustrated in FIG. 2, the user uses the input device 20 to arrange a requirement 101-4 that is subordinate to the approach 102-1. When the requirement 101-4 is arranged, the display control device 10 causes the display of reference information 110 as illustrated in FIG. 3. In the example, the requirement 101-4, problems 111-1 to 111-4, and solutions 112-1 to 112-4 are displayed in the reference information 110.

The problems 111-1 and 111-2 are problems similar to the requirement 101-4 extracted by the problem extractor 13. The solutions 112-1 and 112-2 respectively are solutions for the problems 111-1 and 111-2.

The problems 111-3 and 111-4 respectively are problems associated with the problems 111-1 and 111-2 extracted by the candidate extractor 14. The problems 111-3 and 111-4 are extracted using the ontology respectively based on the problems 111-1 and 111-2. The solutions 112-3 and 112-4 respectively are solutions for the problems 111-3 and 111-4.

The user can use, as an approach for the requirement 101-4, at least one of the solutions 112-1 to 112-4 included in the reference information 110. The reference information 110 may be displayed inside the first editing region 100 or may be displayed in a window other than the first editing region 100.

A function that improves the convenience of the user may be provided for the reference information 110. For example, when the user clicks one of the displayed solutions 112-1 to 112-4 in the reference information 110, the solution is arranged in the first editing region 100 as an approach for the requirement 101-4. Or, when the user clicks one of the problems 111-1 to 111-4 or the solutions 112-1 to 112-4 displayed in the reference information 110, information that relates to the problem or the solution is displayed. For example, the information that is displayed may be at least a part of previous knowledge breakdown information, at least a part of a work report, at least a part of case studies, at least a part of a question-answer list, etc.

The user uses the functions described above to provide mutual subordination between the multiple requirements 101 and the multiple approaches 102. A hierarchical structure for which the editing is completed includes at least one plan for satisfying the requirement 101 of the highest rank. The requirement 101 of the highest rank refers to at least one requirement 101 included in the hierarchical structure and positioned at the highest rank. For example, the requirement 101 of the highest rank is the requirement 101 set as a child of the object 103 positioned at the highest rank (the root) of the hierarchical structure. The plan includes at least one approach. The plan extractor 15 extracts the plan from the edited hierarchical structure. When multiple requirements 101 are set as the children of the object 103, the combination of the approaches 102 for satisfying the multiple requirements 101 of the highest rank are extracted as the plans. When multiple approaches 102 are subordinate to one item in the hierarchical structure, this means that multiple plans exist.

For example, first, the plan extractor 15 extracts the requirement 101 of the highest rank in the edited hierarchical structure. Continuing, the plan extractor 15 scans through the items included in the subtree having that requirement 101 as the root and extracts, as the plan, at least one approach 102 included in the items. When multiple requirements 101 are subordinate to one item, the multiple approaches 102 that are subordinate to each of these requirements 101 are included in the plans. When multiple approaches 102 are subordinate to one item, a plan is generated for each combination of these approaches 102. When multiple requirements 101 of the highest rank exist, at least one approach 102 up to the end for each of the requirements 101 is extracted for each of the requirements 101; and the combinations of these approaches 102 are extracted as plans.

In the example illustrated in FIG. 2, two requirements 101-1 and 101-2 that are necessary to realize the object 103 are set. One approach 102-3 is subordinate to the requirement 101-2. On the other hand, the approach 102-1 and the approach 102-2 are subordinate to the requirement 101-1. This means that the three plans of a plan including the approach 102-1 and the approach 102-3, a plan including the approach 102-2 and the approach 102-3, and a plan including the approach 102-1, the approach 102-2, and the approach 102-3 exist.

An attribute A1 and an attribute value A2 that relates to the attribute A1 can be set for each approach 102. For example, the cost, the time (the leadtime), the dimensions, the life, the performance, etc., are set as the attributes A1 when a product to be designed/developed is set as the object 103. When it is desirable to perform more detailed organization of the knowledge, for example, material costs, processing costs, transportation costs, etc., may be set as more specific costs. For example, the timing of the market launch, the time from making arrangements to delivery, the development man-hours, the production man-hours, etc., may be set as more specific times. Or, when the customer value is used as an indicator, the number of interviews with the customer, the frequency of the interviews, the depth of the conversation content, etc., may be set as the attributes A1. The content that is set to the attribute A1 is modifiable as appropriate according to the goal of making the hierarchical structure. The attribute values A2 are specific numerical values relating to their attributes A1.

When other multiple approaches 102 are set at ranks lower than one approach 102, the attribute value of the approach 102 of the higher rank is the total of the attribute values of the multiple approaches 102 of the lower ranks. The total value may be input manually by the user or may be input by being calculated automatically by the support system 1.

A weight B can be set for the requirement 101. The weight is an indicator of the importance or the priority of the requirement. For example, the weight is set to increase as the importance of the requirement 101 increases. For example, the weight is set so that the total of the weights of the requirements 101 of the siblings subordinate to the same one item is 1.0 (100%). Or, the proportion of the weight set to each requirement 101 to the total of the weights may be used as the weight of each requirement 101.

When other multiple requirements 101 are set at ranks lower than one requirement 101, the substantial weight of each requirement 101 of the lower ranks is the product of the weight of the requirement 101 of the higher rank and the weight of each requirement 101 of the lower rank. For example, the substantial weight of the requirement 101-3 is 0.42, i.e., the product of the weight of 0.7 of the requirement 101-1 and the weight of 0.6 of the requirement 101-3.

The calculator 16 extracts the attributes and their attribute values for the plans extracted by the plan extractor 15 and calculates the total of the attribute values for each attribute. For each plan, the calculator 16 calculates the substantial weights of the requirements. In the example of FIG. 2, the total of the costs and the substantial weights of the requirements are calculated by the calculator 16 for at least one of the plans.

Among the attribute values, a minimum attribute value, a standard attribute value, and a maximum attribute value may be set for one attribute as in the approach 102-3. In such a case, the calculator 16 calculates the total of the minimum attribute values, the total of the standard attribute values, and the total of the maximum attribute values for one plan.

Employment information also may be provided for the approach 102. As described above, when multiple approaches 102 are subordinate to one item, the plan branches into a plurality. As the hierarchical structure becomes deeper, the branches of the plan increase; and the number of plans becomes enormous. Therefore, in the edited hierarchical structure, the user can provide employment information for the object to be employed or the approach 102 that is a candidate to be employed. For example, the user can provide multiple types of employment information.

In the example illustrated in FIG. 2, numerical values C1 and C2 that indicate the employment information are marked respectively on the approaches 102-1 and 102-2. The approaches 102 that are marked with the same numerical value are employed in one common plan. For example, when approaches 102 provided with employment information exist, the calculator 16 performs the calculation of the total of the attribute values, the calculation of the weights, etc., only for the plans including those approaches 102.

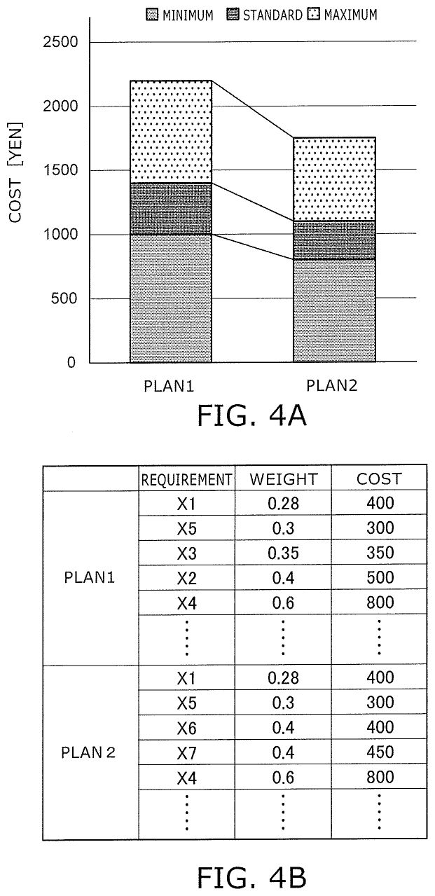

The outputter 18 outputs the calculation results of the calculator 16 to, for example, a GUI. FIGS. 4A and 4B illustrate calculation results relating to a hierarchical structure other than that of FIG. 2. For example, as illustrated in FIG. 4A, the outputter 18 displays the visualization of the total of the minimum attribute values, the total of the standard attribute values, and the total of the maximum attribute values of the attributes for each plan.

As illustrated in FIG. 4B, the outputter 18 may output the substantial weights of the requirements 101 and the totals of the attribute values of the approaches 102 satisfying the requirements 101 for each plan. For example, the outputter 18 arranges the requirements 101 in order of increasing weight. Thereby, the user easily can ascertain whether or not the attribute values match the set weights.

In the first editing region 100, a state in which both the requirement 101 and the approach 102 are subordinate to one requirement 101 or one approach 102 is not permitted. The notifier 17 notifies the user when both the requirement 101 and the approach 102 are subordinate to one item.

For example, when one of a new requirement 101 or a new approach 102 is subordinate to one item, the notifier 17 determines whether or not the other of the requirement 101 or the approach 102 is subordinate to the sibling items of the one item. When both the requirement 101 and the approach 102 are subordinate to one item, the notifier 17 displays a warning phrase to the user in the first editing region 100. For example, the calculator 16 does not perform the calculations relating to the attribute values and the weights until such an unpermitted state is resolved.

In the edited hierarchical structure, the item of an end (a leaf) typically is the approach 102. This is because when an end is the requirement 101, this means that an approach for satisfying the requirement 101 does not exist. For example, the notifier 17 emits a notification to the user in such a case as well. However, the end may be the requirement 101 when a realistic approach 102 for satisfying the requirement 101 does not exist. Accordingly, when the end is the requirement 101, the calculator 16 may perform the calculations relating to the attribute values and the weights.

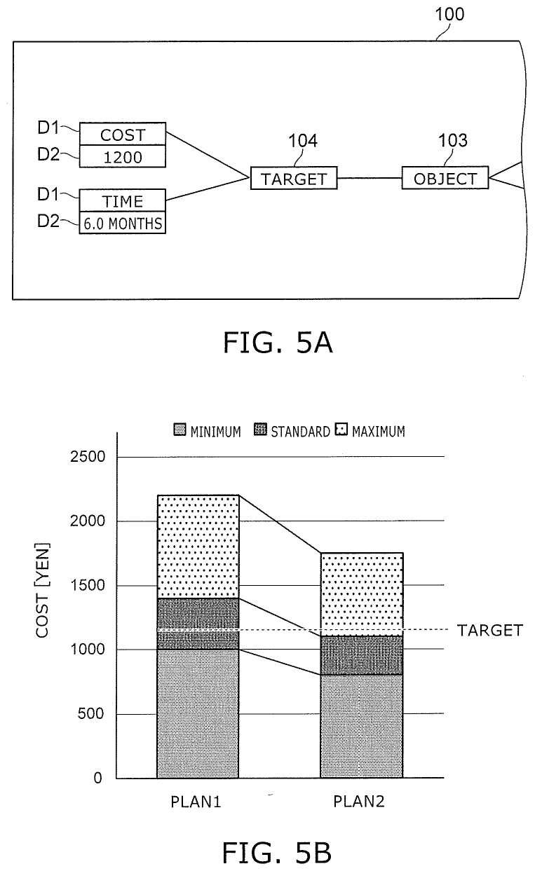

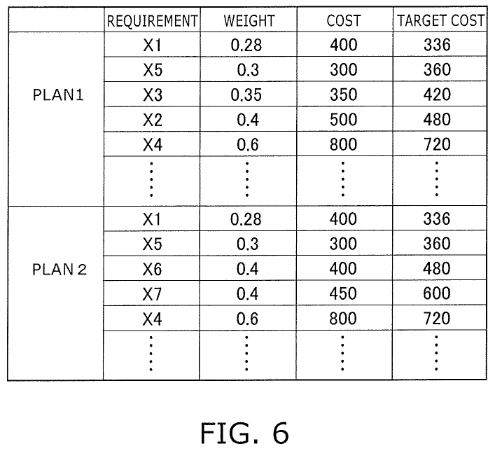

In the first editing region 100 as illustrated in FIG. 5A, a target 104 also may be subordinate to the object 103. A target attribute D1 that is an attribute of the target and a target attribute value D2 that relates to the target attribute D1 are subordinate to the target 104. For example, the target attribute corresponds to one attribute that is set for the approaches 102. In such a case, for example, as illustrated in FIG. 5B, the outputter 18 may display the total of the attribute values calculated for each plan compared to the target attribute value. Or, for each plan, in addition to the calculation results illustrated in FIG. 4B, the calculator 16 may display the products of the target attribute values and the substantial weights of each of the requirements 101 corresponding to each of the requirements 101. For each of the requirements 101, the product of the target attribute value and the substantial weight of the requirement 101 represents the target attribute value. In the example illustrated in FIG. 6, the target attribute value is displayed as the “target cost.” Thereby, the attribute value that is necessary to achieve each requirement 101 is clear.

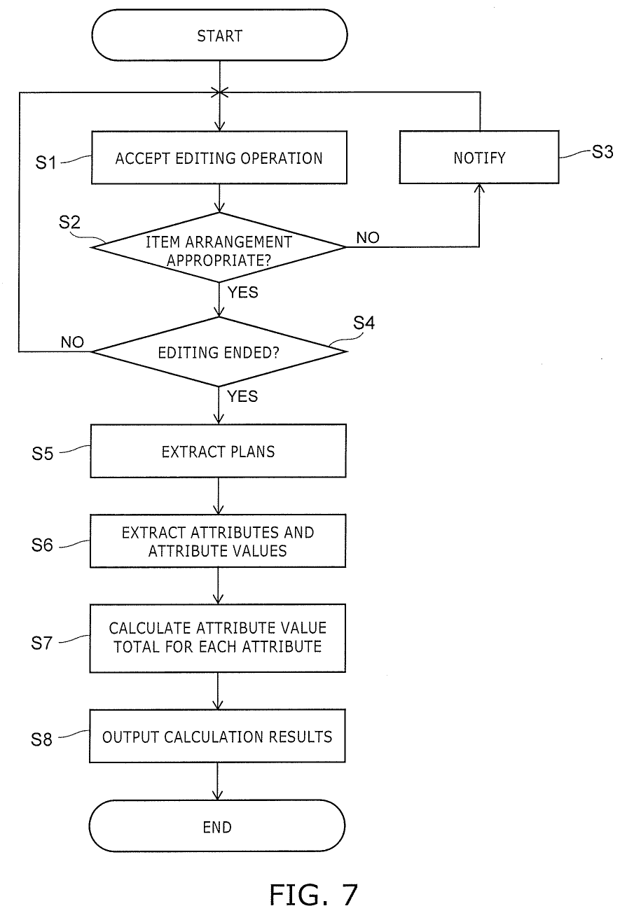

FIG. 7 is a flowchart illustrating the operation of the support system according to the embodiment.

First, the first editing region 100 is displayed by the editor 12; and editing operations in the first editing region 100 are accepted (step S1). The notifier 17 notifies the user when an inappropriate item arrangement occurs when editing (steps S2 and S3). For example, as described above, the notifier 17 notifies the user that the arrangement of the items is inappropriate when the requirement 101 and the approach 102 are subordinate to one item. Steps S1 and S2 are repeated until an operation indicating the end of the editing is input (step S4). When the hierarchical structure relating to the object 103 is made in the first editing region 100, the plans are extracted from the hierarchical structure by the plan extractor 15 (step S5). The calculator 16 extracts the attributes and the attribute values from the extracted plans (step S6) and calculates the total of the attribute values for each attribute (step S7). The outputter 18 outputs the calculated totals of the attribute values (step S8). In step S8, when target attributes and target attribute values are included in the hierarchical structure that is made, the outputter 18 also may output the target attribute values appropriately corresponding to the totals of the attribute values.

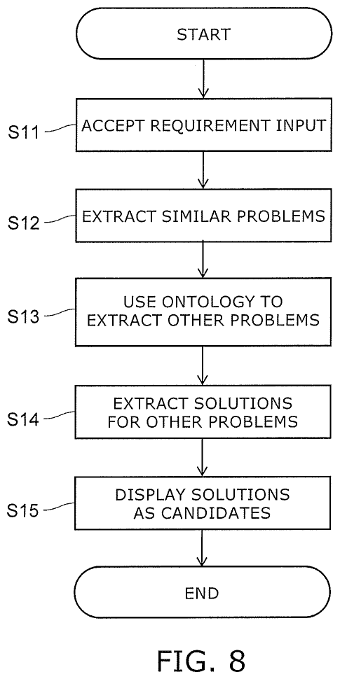

FIG. 8 is a flowchart illustrating the operation of the support system according to the embodiment.

FIG. 8 illustrates the operation when a requirement is arranged in the first editing region 100. The acceptor 11 accepts the input of the requirement 101 to the first editing region 100 (step S11). The problem extractor 13 refers to the memory device 40 and extracts problems similar to the input requirement (step S12). The candidate extractor 14 uses the ontology to extract other problems from the extracted problems (step S13). The candidate extractor 14 also extracts solutions for the other problems (step S14). The outputter 18 displays the extracted solutions as candidates of approaches for the requirement 101 that was arranged (step S15).

Effects of the embodiment will now be described.

In the support system 1 according to the embodiment, when the requirement 101 is input to the first editing region 100, candidates of approaches for the input requirement 101 are displayed by the problem extractor 13 and the candidate extractor 14. The user can employ the displayed candidates as approaches for the requirement 101. Therefore, the user can perform knowledge breakdown efficiently even when the user does not have sufficient knowledge relating to the object 103 of the knowledge breakdown. According to the embodiment, efficient knowledge breakdown by the user can be supported.

In addition to the candidates of the approaches for the input requirement 101, the candidate extractor 14 may further display at least one of a problem similar to the requirement 101, a solution for the problem, or another problem based on an ontology. Because such information is displayed, the user can obtain knowledge other than the candidates. Also, the user can ascertain upon what kind of information the extraction of the candidate was based.

A specific example of the operation of the support system 1 according to the embodiment will now be described.

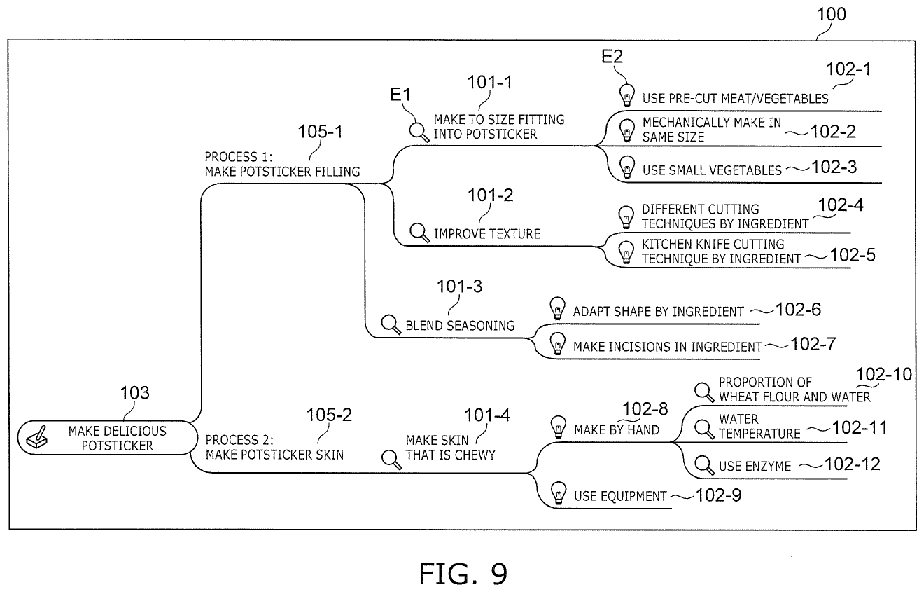

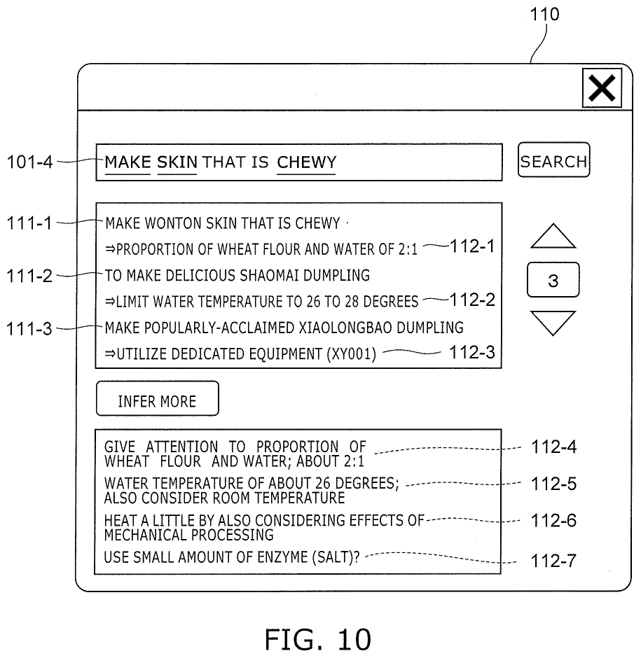

FIG. 9 and FIG. 10 are schematic views illustrating GUIs output by the support system according to the embodiment.

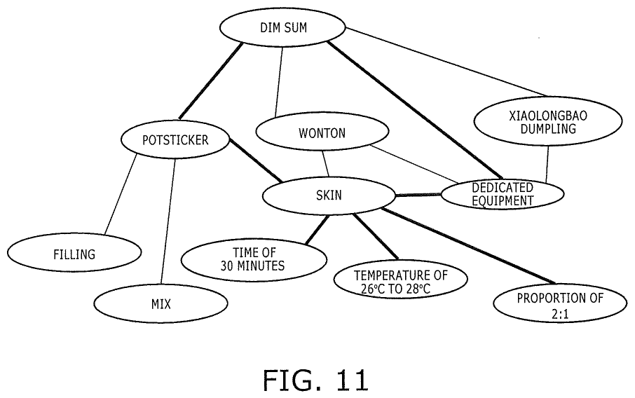

FIG. 11 is a schematic view illustrating a part of an ontology.

In the example of FIG. 9, “make delicious potsticker” is set as the object 103. In the example, knowledge breakdown for “make delicious potsticker” is performed using the support system 1 according to the embodiment. Also, a mark E1 that indicates the requirement 101 and a mark E2 that indicates the approach 102 are marked so that the requirement 101 and the approach 102 can be differentiated easily.

In the example of FIG. 9, memos 105-1 and 105-2 are subordinate to the object 103. The memos are notes for organizing the knowledge. The memos are not treated as a requirement or an approach and do not affect the plans.

The requirements 101-1 to 101-3 are subordinate to the memo 105-1. The requirement 101-4 is subordinate to the memo 105-2. Because the memos are not treated as requirements, the requirements 101-1 to 101-4 are the requirements of the highest rank. The approaches 102-1 to 102-3 are subordinate to the requirement 101-1. The approaches 102-4 and 102-5 are subordinate to the requirement 101-2. Approaches 102-6 and 102-7 are subordinate to the requirement 101-3.

The operation of the display control device 10 when the requirement 101-4 is input will now be described. When the requirement 101-4 is input, the problem extractor 13 refers to the memory device 40. Multiple combinations of problems and solutions for the problems for fields relating to potstickers are stored in the memory device 40. The problem extractor 13 refers to the multiple problems stored in the memory device 40.

The multiple problems and the multiple solutions may be extracted by the problem extractor 13 from documents (work reports, case studies, etc.) stored in the memory device 40. For example, the problem extractor 13 analyzes the documents by using text analysis technology (or natural language processing technology). For example, at least one of named entity extraction technology, important phrase extraction technology, or relationship extraction technology is used as the text analysis technology. In named entity extraction technology, proper nouns such as part names, etc., are extracted from documents. In important phrase extraction technology, important phrases such as important part names, material names, etc., are extracted from documents. In important phrase extraction technology, for example, TF-IDF (Term Frequency Inverse Document Frequency) is utilized. In relationship extraction technology, the relationship between phrases is extracted from documents.

The problem extractor 13 extracts important words and the relationships between the words from the documents and generates the combinations of problems and solutions. The problem extractor 13 analyzes multiple documents and pre-generates a database including multiple combinations of problems and solutions. The problem extractor 13 stores the generated database in the memory device 40. For example, the problem extractor 13 refers to the database when extracting problems similar to the input requirement.

The problem extractor 13 converts the requirement 101-4 and the multiple problems into features. For example, the problem extractor 13 performs morphological analysis of the requirement 101-4. In the morphological analysis, the requirement 101-4 is broken down into multiple words; and the part of speech of each word is estimated. After estimating the part of speech of each word, the problem extractor 13 extracts words of designated parts of speech. For example, the problem extractor 13 extracts the words that are of the three parts of speech of noun, verb, and adjective from the multiple words included in the requirement 101-4. By extracting the words of the designated parts of speech, the effects of the fluctuation of the expressions, paraphrasing, etc., can be removed. The problems that are similar to the input requirement can be extracted more appropriately thereby.

One or more words extracted from the requirement 101-4 and the multiple problems each are input by the problem extractor 13 to a semantic space model, projected into semantic space, and vectorized. Thereby, the one or more words extracted from the requirement 101-4 and the multiple problems each are converted into features. Technology such as Word2Vec, Sentence2Vec, Paragraph2Vec, Doc2Vec, or the like is used to project into semantic space. The features of the multiple problems may be pre-calculated and stored in the memory device 40. In such a case, the problem extractor 13 refers to the pre-calculated features of the multiple problems.

The problem extractor 13 calculates each distance between the features based on the requirement 101-4 and the features of the multiple problems. The problem extractor 13 uses the multiple calculated distances as the respective similarities between the requirement 101-4 and the multiple problems. For example, the problem extractor 13 extracts one or more problems from the multiple problems in order of decreasing similarity. FIG. 10 illustrates the reference information 110 displayed by the display control device 10 for the example of FIG. 9. The requirement 101-4, the problems 111-1 to 111-3 that are similar to the requirement 101-4, and the solutions 112-1 to 112-3 for the problems 111-1 to 111-3 are displayed in the reference information 110. The problems 111-1 to 111-3 are problems that are extracted by the problem extractor 13 and are similar to the requirement 101-4.

The candidate extractor 14 refers to the ontology and extracts one or more other problems associated with the one or more extracted problems. FIG. 11 illustrates a part of the ontology relating to the words included in the problem 111-1. For example, in the ontology as illustrated in FIG. 11, multiple words that have mutually-associated concepts are associated with each other. In the example of FIG. 11, a thicker line illustrates a higher conceptual relevancy. Using this ontology, the candidate extractor 14 extracts other problems associated with the problems 111-1 to 111-3.

The candidate extractor 14 displays the solutions 112-4 to 112-7 for the problems extracted using the ontology as candidates of approaches for the requirement 101-4. In the example of FIG. 10, the candidate extractor 14 also displays the solutions 112-1 to 112-3 for the problems 111-1 to 111-3. The user can use at least one of the solutions 112-1 to 112-7 included in the reference information 110 as the approaches for the requirement 101-4. In the example of FIG. 10, the problems that are extracted using the ontology also may be displayed in the reference information 110.

In the requirement 101-4 that is displayed in the reference information 110, the candidate extractor 14 may display a part of the multiple words in a form different from the form of the other words. For example, among the multiple words included in the requirement 101-4, the candidate extractor 14 displays a part of the multiple words utilized when extracting the problems similar to the requirement 101-4 to be differentiable from the other words. By such a display, the user easily can ascertain upon which words the extraction of the similar problems is based, etc.

The display control device 10 may cause the display device 30 to display an icon, etc., for displaying a part of the multiple words utilized when extracting the problems similar to the requirement 101-4 to be differentiable from the other words. For example, the user can switch between the displays by clicking the icon.

For example, software for putting a Mind Map (registered trademark) into practice can be utilized for the edit functions of the editor 12 described above. For example, FreeMind, XMind, etc., can be utilized as such software. In the first editing region 100, the items that represent the requirements 101 and the items that represent the approaches 102 are marked respectively with information indicating whether each is a requirement or an approach. Based on such information, in the support system 1, the plan extractor 15 extracts the plans; and the calculator 16 calculates the total of the attribute values and the substantial weights for the requirements 101 and the approaches 102 included in the plans.

As illustrated in FIG. 9, the position of each item, the spacing between the items, etc., are arbitrary as long as the subordinate relationship between the requirements 101 and the approaches 102 is represented. Also, an approach 102 for which the attributes and the attribute values are not set may exist.

According to the embodiments described above, a support system, a program, and a storage medium can be provided in which efficient knowledge breakdown by the user can be supported.

For example, the processing of the various data recited above is performed based on a program (software). For example, a computer (a processing device) stores the program and performs the processing of the various information recited above by reading the program.

The processing of the various information recited above may be recorded in a magnetic disk (a flexible disk, a hard disk, etc.), an optical disk (CD-ROM, CD-R, CD-RW, DVD-ROM, DVD±R, DVD±RW, etc.), semiconductor memory, or another recording medium as a program that can be executed by a computer.

For example, the information that is recorded in the recording medium can be read by a computer (or an embedded system). The recording format (the storage format) of the recording medium is arbitrary. For example, the computer reads the program from the recording medium and causes a CPU to execute the instructions recited in the program based on the program. The computer may acquire (or read) the program via a network.

At least a part of the processing of the information recited above may be performed by various software operating on a computer (or an embedded system) based on a program installed in the computer from a recording medium. The software includes, for example, an OS (operating system), etc. The software may include, for example, middleware operating on a network, etc.

The recording medium according to the embodiments stores a program that can cause a computer to execute the processing of the various information recited above. The recording medium according to the embodiments also includes a recording medium to which a program is downloaded and stored using a LAN, the Internet, etc. The processing recited above may be performed based on multiple recording media.

The computer according to the embodiments includes one or multiple devices (e.g., personal computers, etc.). The computer according to the embodiments may include multiple devices connected by a network. In the support system according to the embodiments, a part of the processing by the display control device may be performed via a network using a cloud service, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A support system, comprising:
an editor displaying a first editing region, a plurality of items being editable in the first editing region as a hierarchical structure having mutual subordination, the plurality of items including a requirement and an approach, the approach being for satisfying the requirement;
a problem extractor extracting, from a database when the requirement is input to the first editing region, a problem similar to the input requirement, the database including a plurality of combinations, the combination including the problem and a solution, the solution being for the problem; and
a candidate extractor referring to an ontology, extracting an other problem associated with the extracted problem, and displaying the solution for the other problem as a candidate of the approach for the input requirement.

2. The system according to claim 1, wherein when causing the display of the solution for the other problem, the candidate extractor further causes a display of the similar problem and an other solution for the similar problem.

3. The system according to claim 1, wherein
the problem extractor extracts the similar problem based on a part of a plurality of words included in the input requirement, and
when causing the display of the solution for the other problem, the candidate extractor can display, in a form different from a form of an other part of the plurality of words, the part of the plurality of words used in the extracting of the similar problem.

4. The system according to claim 1, wherein the problem extractor extracts the similar problem from the plurality of problems based on similarities between a feature of the input requirement and features of the plurality of problems.

5. The system according to claim 4, wherein the problem extractor calculates the features of the input requirement and the plurality of problems by projecting the input requirement and the plurality of problems into a semantic space by using a semantic space model.

6. The system according to claim 1, further comprising a plan extractor extracting, as a plan, a set of the approaches for satisfying the requirement of a highest rank in the hierarchical structure.

7. A storage medium storing a program causing a processing device to function as:
an editor displaying a first editing region, a plurality of items being editable in the first editing region as a hierarchical structure having mutual subordination, the plurality of items including a requirement and an approach, the approach being for satisfying the requirement;
a problem extractor extracting, from a database when the requirement is input, a problem similar to the input requirement, the database including a plurality of combinations, the combination including the problem and a solution, the solution being for the problem; and
a candidate extractor referring to an ontology, extracting an other problem associated with the extracted problem, and displaying the solution for the other problem as a candidate of the approach for the input requirement.
